(19) United States
(12) Patent Application Publication
(10) Pub. No.: US 2023/0104608 A1
(43) Pub. Date: Apr. 6, 2023

(54) UNIVERSAL HEADPIECE SYSTEM

(71) Applicants: Michael Scott Kain, Coeur d'Alene, ID (US); Michael Alan Cadwallader, Coeur d'Alene, ID (US)

(72) Inventors: Michael Scott Kain, Coeur d'Alene, ID (US); Michael Alan Cadwallader, Coeur d'Alene, ID (US)

(21) Appl. No.: 17/960,634

(22) Filed: Oct. 5, 2022

Related U.S. Application Data
(60) Provisional application No. 63/252,715, filed on Oct. 6, 2021.

(51) Int. Cl. A61G 13/12; A61G 13/00

(52) U.S. Cl. CPC A61G 13/121; A61G 13/009

(57) ABSTRACT

In aspects of a universal headpiece system, a headpiece rail mount is adaptively attachable to a massage table. Releasable inserts insert through headpiece mounting ports in the massage table and secure the headpiece rail mount to the massage table. The headpiece rail mount is configured for removeable attachment of a headpiece cradle. The headpiece rail mount includes hole brackets universal alignment with any configuration of the headpiece mounting ports in a massage table. The hole brackets are configured for insertion of the releasable inserts that are each insertable through one of the headpiece mounting ports in the massage table and into a respective hole bracket for securing the headpiece rail mount to the massage table.

### RELATED APPLICATION

This application claims priority to U.S. Provisional Patent Application Ser. No. 63/252,715 filed 6 Oct. 2021 entitled “Massage Table Universal Headpiece System”, the disclosure of which is incorporated by reference herein in its entirety.

### BACKGROUND

In the massage industry, the current table headpiece options are fixed in one location on the table, and conventional massage tables do not allow the face cradle to be moved. Further, current headpiece options do not provide a universal or standardized face cradle that can be utilized on different massage tables, which are manufactured by different companies with different specifications for the connection and anchoring of the face cradle to a massage table. Notably, these challenges result in a massage therapist having to position a client on a massage table, rotating his or her head to one side while in the prone position, which puts undue stress on the cervical spine, upper thoracic spine, as well as on the shoulders of the client person. Further, the massage therapist is forced to also contort into poor postural positions, jeopardizing overall body mechanics and impacting the health and longevity of the massage therapist. Current research indicates that the average career of a massage therapist is only six years, primarily due to the strain put on the practitioners due to massage table and headpiece limitations.

### BRIEF DESCRIPTION OF THE DRAWINGS

The detailed description is described with reference to the accompanying figures.

FIG. 1 illustrates an example massage table that includes headpiece mounting ports for a headpiece cradle, which supports a universal headpiece system, as described herein.

FIG. 2 illustrates an example of a universal headpiece system installed for attachment under an inside end of the massage table in accordance with one or more implementations as described herein.

FIG. 3 illustrates examples of configurations of a mounting block, slide attachment, and slideable component, in accordance with one or more implementations of a universal headpiece system as described herein.

FIG. 4 illustrates an example of various components of the universal headpiece system, in accordance with one or more implementations as described herein.

FIG. 5 illustrates examples of releasable inserts and quick release, cam lever locking pins engaged with the releasable inserts, in accordance with one or more implementations of a universal headpiece system as described herein.

FIG. 6 further illustrates an example of a releasable insert implemented as threaded mounting bolt having the option for quick release or anchor attachment, in accordance with one or more implementations of a universal headpiece system as described herein.

FIG. 7 illustrates an example of various components of a universal headpiece system, in accordance with one or more implementations as described herein.

FIG. 8 illustrates example views of a massage table with a universal headpiece system attached, including a headpiece cradle, in accordance with one or more implementations as described herein.

FIGS. 9 and 10 further illustrate examples of a multi-positionable headpiece cradle, in accordance with one or more implementations as described herein.

FIG. 11 illustrates examples of headpiece cradle lateral movement on different sized massage tables, in accordance with one or more implementations of a universal headpiece system as described herein.

FIGS. 12-14 illustrate example sequences of attaching and securing a universal headpiece system to a massage table, in accordance with one or more implementations as described herein.

FIG. 15 illustrates an example end view of various components of the universal headpiece system, in accordance with one or more implementations as described herein.

FIG. 16 illustrates example method(s) for a universal headpiece system in accordance with one or more implementations, as described herein.

### DETAILED DESCRIPTION

A versatile and universally attachable massage table headpiece system moves laterally, vertically, as well as in incline and decline directions. The described universal headpiece system is adjustable for attachment to any massage table and accommodates any table manufacturer specifications of consumer available massage tables. The universal headpiece system is universally attachable to massage tables, yet is also removable, portable, and fits different tables from different manufacturers.

In the massage industry, it is not currently possible to move a client to the edge of a massage table and still utilize the attached table headpiece. The current table headpiece options are fixed in one location on the table, and conventional massage tables do not allow the face cradle to move laterally along the edge of the table. Further, current headpiece options do not have the ability to be easily secured to a massage table, and there is not a universal or standardized face cradle that can be utilized on different massage tables, which are manufactured by different companies with different specifications for the connection and anchoring of the face cradle to a massage table. Notably, these challenges result in a massage therapist having to position a client on a massage table, rotating his or her head to one side while in the prone position, which puts undue stress on the cervical spine, upper thoracic spine, as well as on the shoulders of the client person. Further, the massage therapist is forced to also contort into poor postural positions, jeopardizing overall body mechanics and impacting the health and longevity of the massage therapist.

The disclosure describes a universal headpiece system that allows a massage therapist to move a client into different positions on the massage table, enabling both the client and the massage therapist to maintain proper posture, while at the same time maximizing technique application and preventing unnecessary injury to either person. This also allows the massage therapist the ability to sit down while providing quality care, and may allow a wheelchair bound massage therapist to easily access a client. The universal headpiece system also allows the massage therapist to move the client to a side edge of the table, allowing for proper body mechanics, maximizing leverage, and ensuring comfort and longevity in the career.

In some aspects of the techniques described herein, a universal headpiece system includes a headpiece rail mount that adaptively attaches to a massage table. Releasable inserts insert through headpiece mounting ports in the massage table and secure the headpiece rail mount to the massage table. The headpiece rail mount is configured for removeable attachment of a headpiece cradle.

In some aspects of the techniques described herein, the headpiece rail mount is configured for quick release attachment to the massage table, and in an implementation, the headpiece rail mount is installable for adaptive attachment under an inside end of the massage table. The headpiece cradle is configured for quick release attachment to the headpiece rail mount. The headpiece rail mount includes a slidable headpiece attachment for the removeable attachment of the headpiece cradle, and the slidable headpiece attachment slides laterally relative to an end of the massage table to translate the headpiece cradle from a first side edge of the massage table to a second side edge of the massage table.

In some aspects of the techniques described herein, the headpiece rail mount includes hole brackets for universal alignment with any configuration of the headpiece mounting ports in the massage table. The hole brackets are slideable along the headpiece rail mount for alignment with the headpiece mounting ports in the massage table, and the hole brackets configured for insertion of the releasable inserts.

In some aspects of the techniques described herein, the releasable inserts secure the headpiece rail mount to the massage table with quick release, cam lever locking pins. The releasable inserts can be mounting bolts configured for quick release locking, or threaded mounting bolts configured for either the quick release locking or threaded attachment of an anchor that secures the headpiece rail mount to the massage table.

In some aspects of the techniques described herein, foldable leverage support arms can be implemented for torque stability of the universal headpiece system, where the foldable leverage support arms fold out from the headpiece rail mount.

In other aspects of the techniques described herein, a headpiece rail mount includes hole brackets for universal alignment with any configuration of headpiece mounting ports in a massage table. The hole brackets are configured for insertion of releasable inserts that are each insertable through one of the headpiece mounting ports in the massage table and into a respective hole bracket. A slidable headpiece attachment removably attaches a headpiece cradle to the massage table.

In some aspects of the techniques described herein, the slidable headpiece attachment is for quick release attachment of the headpiece cradle, and the slidable headpiece attachment slides laterally relative to an end of the massage table to translate the headpiece cradle from a first side edge of the massage table to a second side edge of the massage table.

In some aspects of the techniques described herein, the hole brackets are slideable along the headpiece rail mount for alignment with the headpiece mounting ports in the massage table. The releasable inserts are configured for quick release attachment of the headpiece rail mount to the massage table, and in an implementation, the releasable inserts secure the headpiece rail mount to the massage table with quick release, cam lever locking pins.

In other aspects of the techniques described herein, a method includes aligning, by hole brackets of a headpiece rail mount, with any configuration of headpiece mounting ports in a massage table; securing, by releasable inserts through the headpiece mounting ports and the hole brackets, the headpiece rail mount to the massage table; and sliding, by a slidable headpiece attachment of the headpiece rail mount, a headpiece cradle. In an implementation, the method further includes locking the headpiece rail mount to the massage table by cam lever locking pins engaging the releasable inserts.

In some aspects of the techniques described herein, the releasable inserts are for quick releasing the headpiece rail mount to the massage table. The hole brackets are slideable along the headpiece rail mount for the aligning with the any configuration of the headpiece mounting ports in the massage table. The sliding includes the headpiece cradle sliding from a first side edge of the massage table to a second side edge of the massage table.

While features and concepts of the described techniques for a universal headpiece system can be implemented in any number of different devices, systems, environments, and/or configurations, implementations of the techniques for universal headpiece system are described in the context of the following example devices, systems, and methods.

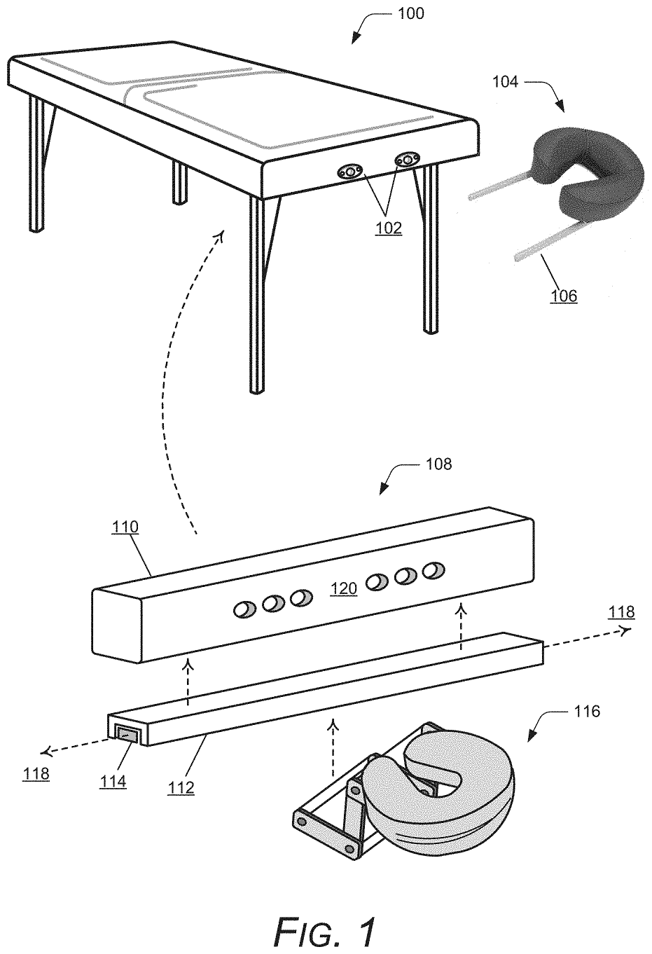

FIG. 1 illustrates an example of a massage table 100 that includes headpiece mounting ports 102 for a headpiece cradle 104, which has rods 106 that slide into the headpiece mounting ports 102 on the end of the massage table. As noted above, the headpiece mounting ports 102 are generally fixed in one location at the end of the massage table 100 by most massage table manufacturers. The fixed location of the headpiece mounting ports 102 does not allow the headpiece cradle 104 to move laterally along the end of the table. Further, typical consumer available massage tables can have an eight inch (8″), a nine inch (9″), or a ten inch (10″) spacing between the mounting ports 102, and headpiece cradles are not universally adaptable to all massage tables, which are manufactured by different companies to different specifications.

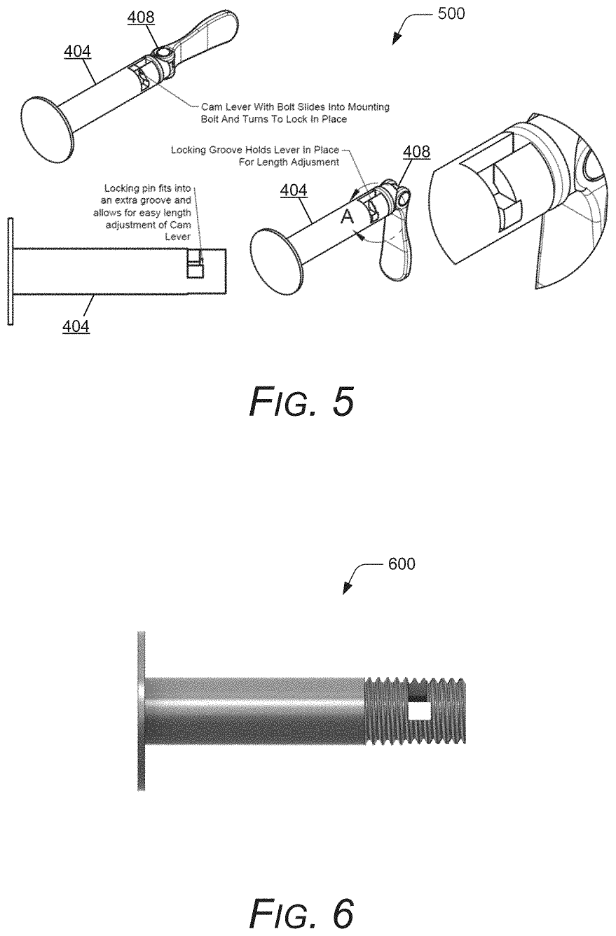

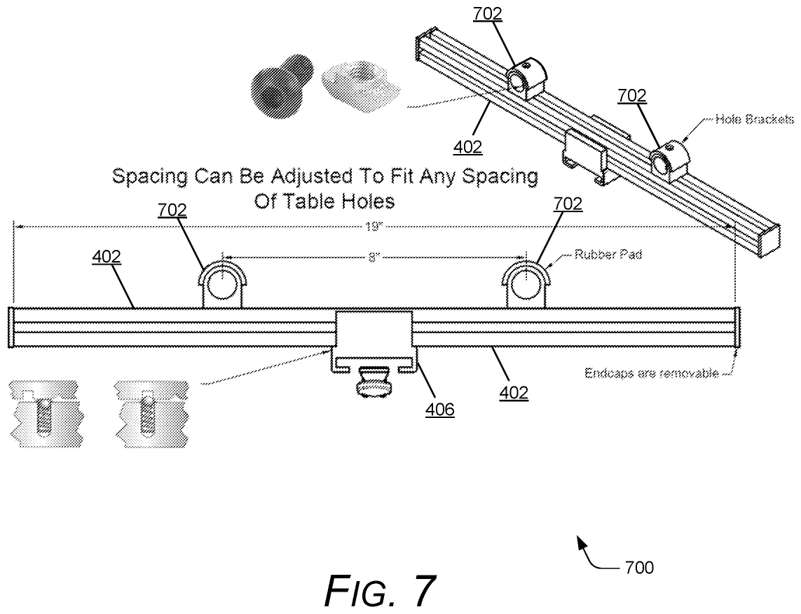

In aspects of a universal headpiece system as described in this disclosure, a universal headpiece system 108 includes a mounting block 110, which can be manufactured with any sturdy and torsionally rigid material, such as wood, aluminum, metal, and the like. For example, in one or more implementations, and as further described and shown in at least FIGS. 4 and 5, the mounting block 110 of the universal headpiece system 108 can be implemented as a headpiece rail mount, which can be adaptively attached to the massage table 100. Additionally, aspects of the universal headpiece system can be utilized for any different types of massage tables, such as a manual, portable, stationary, electric, and/or any other type of massage table.

The universal headpiece system 108 also includes a slide attachment 112, which has a slidable component 114 designed to slide in a parallel channel of the slide attachment. The slide attachment 112 is configured for attaching a headpiece cradle 116, which then slides along the end of the massage table 100 from side-to-side. Similar to the mounting block 110, the slide attachment 112 can be manufactured with any sturdy and torsionally rigid material, such as wood, aluminum, metal, and the like that provides torsional stability, particularly when the slideable component 114 is extended 118 from the parallel channel of the slide attachment 112. For example, in one or more implementations, and as further described and shown in at least FIGS. 4 and 5, the features of the slide attachment and the slidable component are integrated features or components of the headpiece rail mount. Generally, the headpiece cradle 116 can be designed with quick release buttons at several points of rotation for incline and decline positioning. Notably, the headpiece cradle 116 can also swing approximately 180 degrees and lock out of the way back under the massage table.

In this example, the mounting block 110 includes one or more sets of mounting holes 120 through which the universal headpiece system 108 can be attached to any massage table configuration of the headpiece mounting ports 102. Although this example shows the mounting block 110 with two sets of three mounting holes 120, the sets of mounting holes can be configured with any number of mounting holes, such as two each, four each, etc. Additionally, the mounting holes may be aligned (as shown), offset, or in any other pattern that facilitates universal attachment to any different type of consumer available massage tables. For example, in one or more implementations, and as further described and shown in at least FIGS. 4 and 5, the headpiece rail mount includes hole brackets for universal alignment with any configuration of the headpiece mounting ports 102 in a massage table.

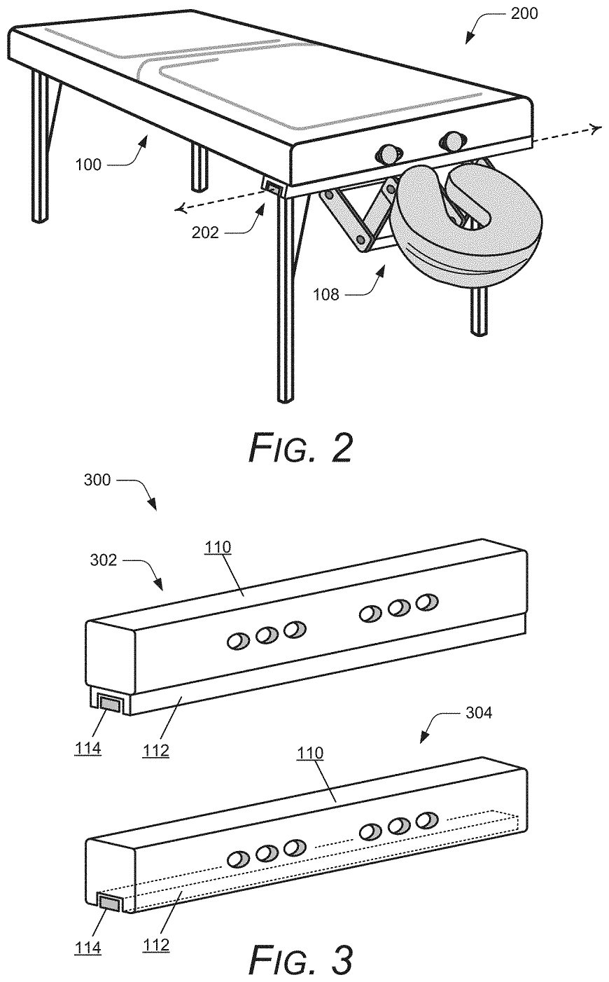

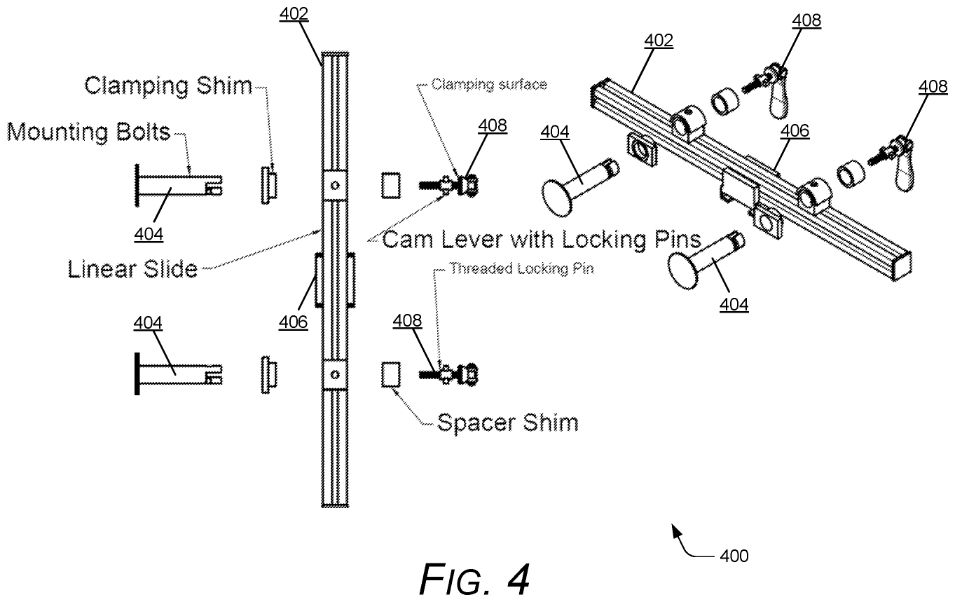

As illustrated, the universal headpiece system 108 can be mounted up under an end (e.g., the front end) of the massage table 100. An example of the installation is described and shown in at least FIG. 2, and as noted, the headpiece cradle 116 attaches to the slideable component 114 of the slide attachment 112, which is then slideable along the end of the massage table 100 from side-to-side in the parallel channel of the slide attachment. In implementations, the slide attachment 112 can be affixed to the bottom of the mounting block 110, as further described and shown in FIG. 3. Alternatively, the slide attachment 112 can be an integrated component that is internal or formed into the mounting block 110, such as further described and shown in FIG. 3.

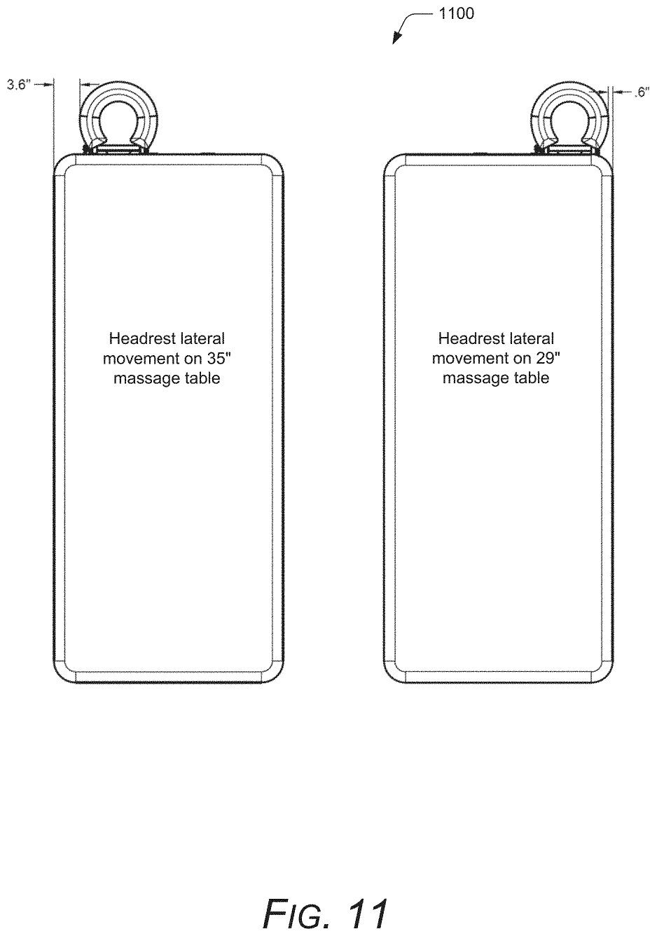

FIG. 2 illustrates an example 200 of the universal headpiece system 108 installed for attachment under an inside end of the massage table 100, as shown at 202. Additional examples of the universal headpiece system 108 installed or mounted under an inside edge of a massage table are further shown and described with reference to FIGS. 8 and 13-16. Additionally, it is notable that a massage table may be foldable, such as for easier transport or travel, and the universal headpiece system 108 can remain installed or attached in a folded configuration of a massage table. With the headpiece cradle 116 removed, the mounting block 110 (e.g., headpiece rail mount) is concealed inside of the folded massage table.

FIG. 3 further illustrates examples 300 of configurations of the mounting block 110, the slide attachment 112, and the slideable component 114. In an implementation shown at 302, the slide attachment 112 can be affixed to the bottom of the mounting block 110. In an alternative implementation shown at 304, the slide attachment 112 can be an integrated component that is internal or formed into the mounting block 110.

FIG. 4 illustrates an example 400 of various components of the universal headpiece system in accordance with one or more implementations, as described herein. The universal headpiece system 108 includes the headpiece rail mount 402 (also referred to herein as the mounting block), which is configured for adaptive attachment to a massage table. In implementations, the headpiece rail mount 402 is configured for quick release attachment to a massage table. Further, the headpiece rail mount 402 includes a slidable headpiece attachment 406 for the removeable attachment of the headpiece cradle 116. In implementations, the headpiece cradle 116 is configured for quick release attachment to the slidable headpiece attachment 406 of the headpiece rail mount.

The universal headpiece system 108 also includes the releasable inserts 404 (e.g., mounting bolts) that can insert through the headpiece mounting ports 102 in the massage table 100 and secure the headpiece rail mount 402 to the massage table. As described herein, the term “releasable” in context of the releasable inserts indicates that the inserts can be implemented as quick release inserts, as a bolt and anchor (e.g., nut attachment), or as a combination thereof, while still maintaining an aspect of being releasable for disassembly of the components from the headpiece rail mount. Alternatively, the releasable inserts may be conventional headpiece cradle attachment rods or prongs that are insertable through the headpiece mounting ports 102 in a massage table. Additionally, the releasable inserts 404 are configured to secure the headpiece rail mount 402 to a massage table with quick release, cam lever locking pins 408. The releasable inserts 404 can be implemented as mounting bolts, such as configured for quick release locking. Similarly, the releasable inserts 404 can be implemented as threaded mounting bolts configured for either the quick release locking or for threaded attachment of an anchor (e.g., a nut on a bolt) to secure the headpiece rail mount 402 to a massage table.

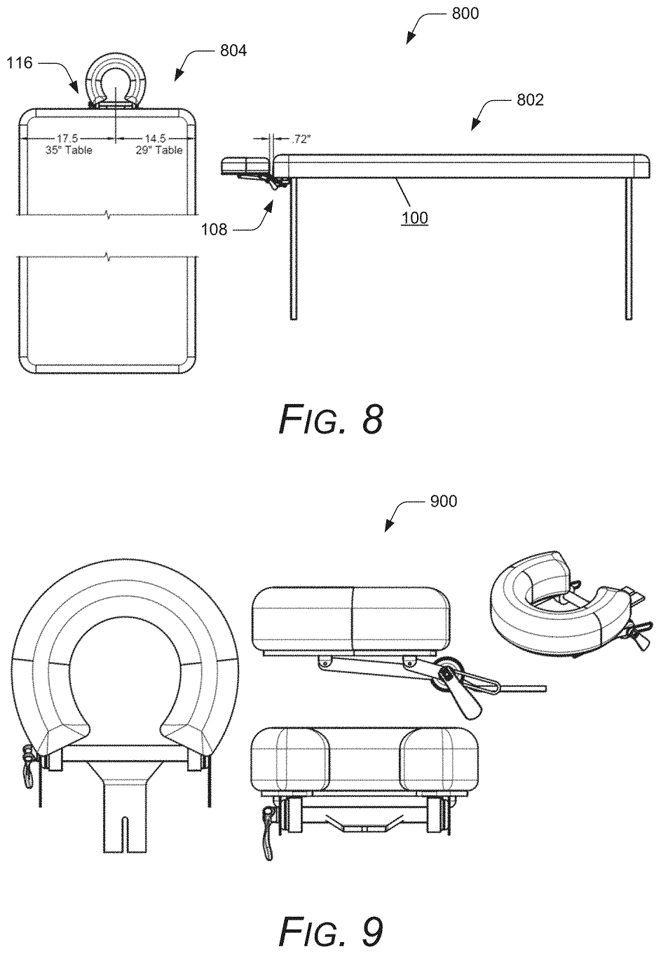

FIG. 5 further illustrates examples 500 of the releasable inserts 404 and the quick release, cam lever locking pins 408 engaged with the releasable inserts. FIG. 6 further illustrates an example 600 of a releasable insert implemented as threaded mounting bolt having the option for quick release or anchor attachment (e.g., a threaded nut to secure the headpiece rail mount to a massage table).

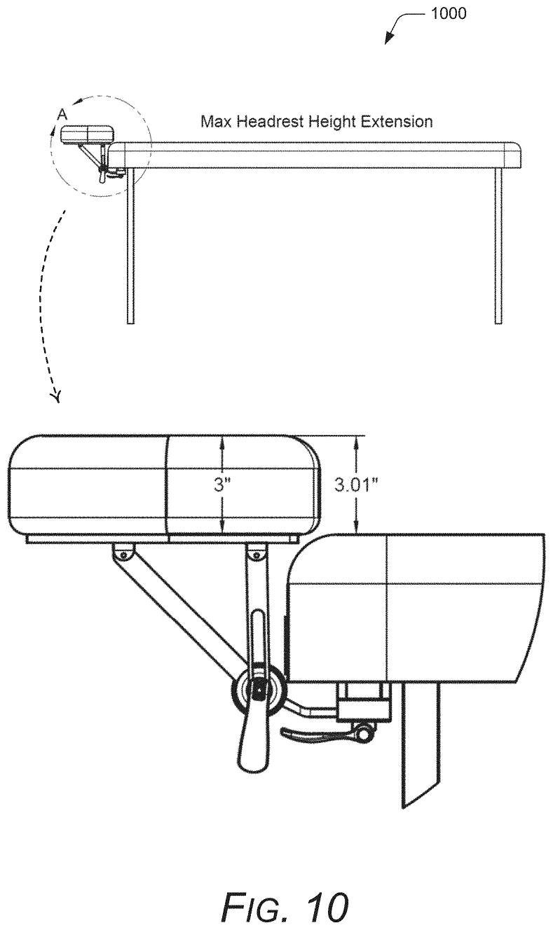

FIG. 7 further illustrates an example 700 of various components of a universal headpiece system in accordance with one or more implementations, as described herein. The universal headpiece system 108 includes the headpiece rail mount 402 (also referred to herein as the mounting block), which is configured for adaptive attachment to a massage table. The universal headpiece system 108 also includes hole brackets 702 (e.g., two hole brackets in this example), which are implemented for universal alignment with any configuration of the headpiece mounting ports in the massage table. In implementations, the hole brackets 702 are slideable along the headpiece rail mount 402 for alignment with the headpiece mounting ports 102 in a massage table. The hole brackets 702 are implemented or designed for insertion of the releasable inserts 404 (e.g., mounting bolts), such as after the releasable inserts 404 are inserted through the headpiece mounting ports 102 from the exterior end of the massage table into the interior underside of the massage table. Notably, the illustrated dimensions are merely shown as example dimensions, and any length of a headpiece rail mount or distance between the hole brackets 702 can be implemented in aspects of a universal headpiece system.

Aspects of the design for the universal headpiece system 108 allows for easy and complete assembly and disassembly of the various components from the headpiece rail mount 402. Further, the universal quick release system complements any length lateral slide (e.g., headpiece rail mount), and lateral slides of various lengths can be utilized separately from any of the quick release features. Notably, every feature can be removed from the headpiece rail mount 402 for use on a different size or configuration headpiece rail mount. Different sized headpiece rail mounts are interchangeable to accommodate different sized massage tables and configurations in aspects of a universal headpiece system.

FIG. 8 illustrates example views 800 of a massage table 100 with a universal headpiece system 108 attached, including the headpiece cradle 116. For example, a side view 802 of the massage table illustrates an example spacing between the headpiece cradle 116 and the end of the massage table. In implementations, the universal headpiece system 108 can be configured to accommodate any spacing and positioning requirements, such as for different sized tables as shown at 804.

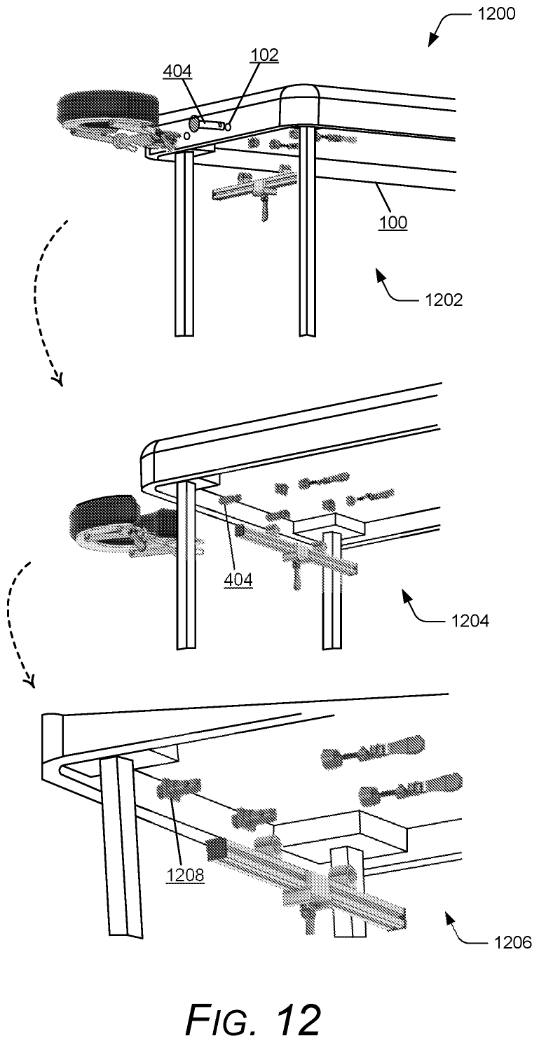

FIG. 9 further illustrates examples 900 of the multi-positionable headpiece cradle 116. FIG. 10 also further illustrates examples 1000 of the multi-positionable headpiece cradle 116. Notably, the illustrated dimensions are merely shown as example dimensions of positioning and movement capabilities, and various components of the headpiece cradle 116. In practice, a universal headpiece system can be implemented to accommodate any positioning, movement, and component sizing.

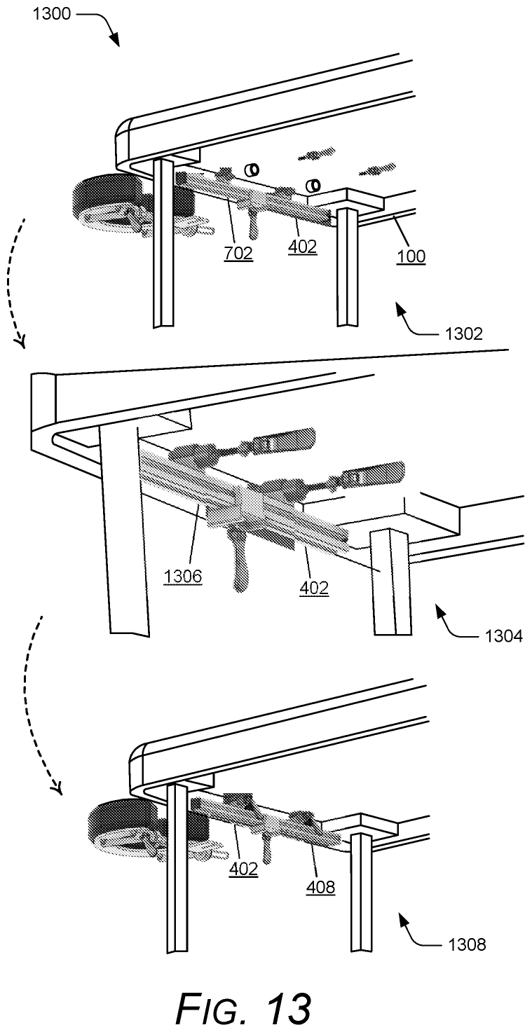

FIG. 11 illustrates examples 1100 of the headpiece cradle 116 lateral movement on different sized massage tables in accordance with implementations of a universal headpiece system as described herein. For example, the headpiece rail mount 402 includes the slidable headpiece attachment 406 that is implemented for the removeable attachment of the headpiece cradle 116, and the slidable headpiece attachment 406 slides laterally relative to an end of the massage table 100 to translate the headpiece cradle 116 from a first side edge of the massage table to a second side edge of the massage table. Notably, the illustrated dimensions are merely shown as example dimensions of slideable positioning of the headpiece cradle 116. In practice, a universal headpiece system can be implemented to accommodate any dimensions for slideable positioning of the headpiece cradle.

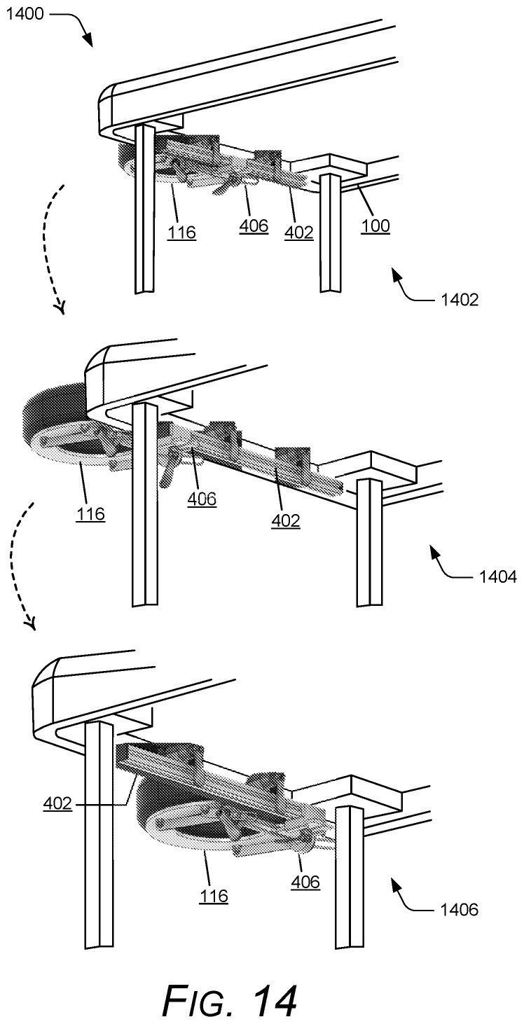

FIG. 12 illustrates an example sequence 1200 of attaching and securing a universal headpiece system 108 to a massage table in accordance with one or more implementations as described herein. Initially, as shown at 1202, the releasable inserts 404 are inserted through the headpiece mounting ports 102 in the massage table 100. As further shown at 1204, the releasable inserts 404 are inserted through the headpiece mounting ports 102 and extend into the interior underside of the massage table. As shown at 1206, clamping shims 1208 may be installed over the releasable inserts 404 on the interior underside of the table.

FIG. 13 further illustrates an example sequence 1300 of attaching and securing a universal headpiece system 108 to a massage table in accordance with one or more implementations as described herein. Continuing from FIG. 12, and as shown at 1302, the hole brackets 702 of the headpiece rail mount 402 are installed or slid onto the releasable inserts 404. As shown at 1304, spacer shims 1306 may also be installed over releasable inserts 404 on the interior underside of the table, and as shown at 1308, the quick release, cam lever locking pins 408 engage the releasable inserts 404 to secure the headpiece rail mount 402 to the massage table.

FIG. 14 further illustrates an example sequence 1400 of attaching and securing a universal headpiece system 108 to a massage table in accordance with one or more implementations as described herein. Continuing from FIG. 13, and as shown at 1402, the headpiece rail mount 402 is installed and secured under the inside end of the massage table 100. Additionally, the headpiece cradle 116 is removably attached to the headpiece rail mount 402 with the slidable headpiece attachment 406, which provides for quick release attachment of the headpiece cradle 116 to the headpiece rail mount. As shown at 1404, the slidable headpiece attachment 406 slides laterally (to the left) relative to the end of the massage table 100 to translate the headpiece cradle 116 from the center or right side edge of the massage table to the left side edge of the massage table. Similarly, as shown at 1406, the slidable headpiece attachment 406 slides laterally (to the right) relative to the end of the massage table 100 to translate the headpiece cradle 116 from the center or left side edge of the massage table to the right side edge of the massage table.

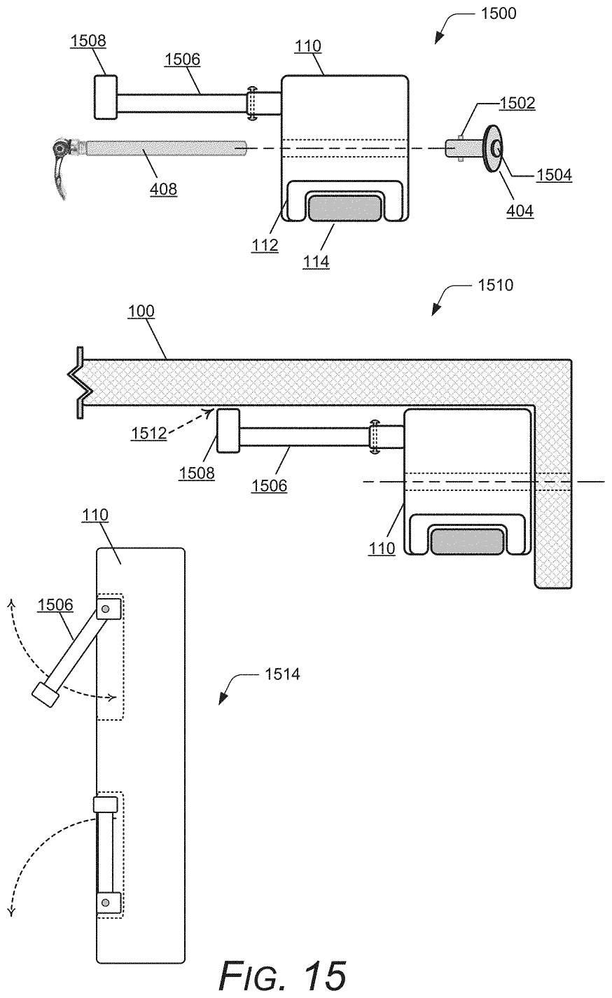

FIG. 15 further illustrates an example end view 1500 of various components of the universal headpiece system 108. This example end view 1500 shows an alternative implementation of the releasable inserts 404 and quick release, cam lever locking pins 408 (e.g., quick release inserts) that are insertable through from under the backside of the massage table 100. In this example, the releasable inserts 404 have a flush mounting cap, which can have detents or releasable pins 1502 that engage the quick release insert. The flush mounting cap may include a quick release 1504, such as a depressable button that disengages the releasable pins 1502 from the quick release insert. The flush mounting cap is flush or approximately flush, allowing a massage therapist to move freely without interference along the outside edge of a massage table. Notably however, the quick release inserts may be installed in either direction, such as from under the backside of the massage table through the mounting block 110 (e.g., headpiece rail mount 402) and through the headpiece mounting ports 102 on the end of the table. Alternatively, the quick release inserts may be installed first through the headpiece mounting ports 102 on the end of the massage table 100, and then through the mounting block 110.

In implementations, the universal headpiece system 108 can also include foldable leverage support arms 1506 which can include a table support 1508 that contacts the underside of the massage table 100 when folded out from the mounting block to provide additional torque stability of the system. As further shown at 1510, the table support 1508 of the foldable leverage support arm 1506 contacts the underside of the massage table 100 at 1512, providing anti-rotational stability that counteracts the force applied when a client's head is resting in the headpiece cradle 116. A top view of the universal headpiece system 108 is further shown at 1514, illustrating the foldable feature of the foldable leverage support arms 1506. In implementations, the foldable leverage support arms 1506 may be attached to the back of the mounting block 110. Alternatively, the foldable leverage support arms 1506 may be recessed and fold into the mounting block 110 (e.g., into the headpiece rail mount 402), as shown in the example at 1514.

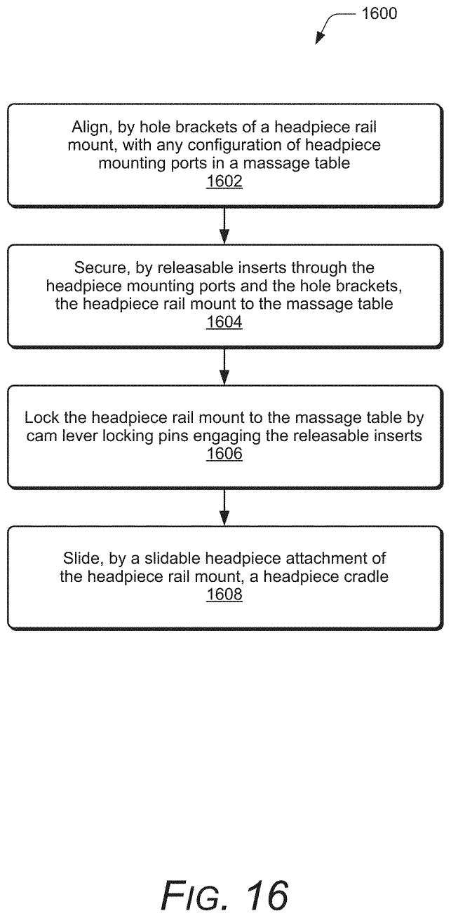

FIG. 16 illustrates example method(s) 1600 of a universal headpiece system. The order in which the method is described is not intended to be construed as a limitation, and any number or combination of the described method operations can be performed in any order to perform a method, or an alternate method.

At 1602, hole brackets of a headpiece rail mount align with any configuration of headpiece mounting ports in a massage table. For example, the hole brackets 702 of the headpiece rail mount 402 align with any configuration of headpiece mounting ports 102 in a massage table. In one or more implementations, the hole brackets 702 are slideable along the headpiece rail mount 402 for aligning with any configuration of the headpiece mounting ports 102 in the massage table.

At 1604, releasable inserts through the headpiece mounting ports and the hole brackets secure the headpiece rail mount to the massage table. For example, the releasable inserts 404 are insertable through the headpiece mounting ports 102 in the massage table, and through the hole brackets 702 in the headpiece rail mount 402 to secure the headpiece rail mount to the massage table.

At 1606, the headpiece rail mount locks to the massage table by cam lever locking pins engaging the releasable inserts. For example, the headpiece rail mount 402 locks to the massage table 100 by the cam lever locking pins 408 engaging the releasable inserts 404.

At 1608, a slidable headpiece attachment of the headpiece rail mount slides a headpiece cradle. For example, the slidable headpiece attachment 406 of the headpiece rail mount 402 slides the headpiece cradle 116. In implementations, the headpiece cradle slides from a first side edge of the massage table to a second side edge of the massage table.

1. A universal headpiece system, comprising:
a headpiece rail mount configured for adaptive attachment to a massage table; and
releasable inserts configured to insert through headpiece mounting ports in the massage table and secure the headpiece rail mount to the massage table, the headpiece rail mount configured for removeable attachment of a headpiece cradle.

2. The universal headpiece system of claim 1, wherein the headpiece rail mount is configured for quick release attachment to the massage table.

3. The universal headpiece system of claim 1, wherein the headpiece cradle is configured for quick release attachment to the headpiece rail mount.

4. The universal headpiece system of claim 1, wherein the headpiece rail mount comprises a slidable headpiece attachment configured for the removeable attachment of the headpiece cradle, and the slidable headpiece attachment is configured to slide laterally relative to an end of the massage table to translate the headpiece cradle from a first side edge of the massage table to a second side edge of the massage table.

5. The universal headpiece system of claim 1, wherein the headpiece rail mount comprises hole brackets configured for universal alignment with any configuration of the headpiece mounting ports in the massage table.

6. The universal headpiece system of claim 5, wherein the hole brackets are slideable along the headpiece rail mount for alignment with the headpiece mounting ports in the massage table, the hole brackets configured for insertion of the releasable inserts.

7. The universal headpiece system of claim 1, wherein the headpiece rail mount is installable for the adaptive attachment under an inside end of the massage table.

8. The universal headpiece system of claim 1, wherein the releasable inserts are configured to secure the headpiece rail mount to the massage table with quick release, cam lever locking pins.

9. The universal headpiece system of claim 1, wherein the releasable inserts are at least one of mounting bolts configured for quick release locking, or threaded mounting bolts configured for either the quick release locking or threaded attachment of an anchor configured to secure the headpiece rail mount to the massage table.

10. The universal headpiece system of claim 1, further comprising foldable leverage support arms configured for torque stability of the universal headpiece system, the foldable leverage support arms configured to fold out from the headpiece rail mount.

11. A headpiece rail mount, comprising:
hole brackets configured for universal alignment with any configuration of headpiece mounting ports in a massage table, the hole brackets configured for insertion of releasable inserts that are each insertable through one of the headpiece mounting ports in the massage table and into a respective hole bracket; and
a slidable headpiece attachment configured for removeable attachment of a headpiece cradle to the massage table.

12. The headpiece rail mount of claim 11, wherein the slidable headpiece attachment is configured for quick release attachment of the headpiece cradle, and the slidable headpiece attachment is configured to slide laterally relative to an end of the massage table to translate the headpiece cradle from a first side edge of the massage table to a second side edge of the massage table.

13. The headpiece rail mount of claim 11, wherein the hole brackets are slideable along the headpiece rail mount for alignment with the headpiece mounting ports in the massage table.

14. The headpiece rail mount of claim 11, wherein the releasable inserts are configured for quick release attachment of the headpiece rail mount to the massage table.

15. The headpiece rail mount of claim 11, wherein the releasable inserts are configured to secure the headpiece rail mount to the massage table with quick release, cam lever locking pins.

16. A method, comprising:
aligning, by hole brackets of a headpiece rail mount, with any configuration of headpiece mounting ports in a massage table;
securing, by releasable inserts through the headpiece mounting ports and the hole brackets, the headpiece rail mount to the massage table; and
sliding, by a slidable headpiece attachment of the headpiece rail mount, a headpiece cradle.

17. The method of claim 16, further comprising locking the headpiece rail mount to the massage table by cam lever locking pins engaging the releasable inserts.

18. The method of claim 16, wherein the releasable inserts are configured for quick releasing the headpiece rail mount to the massage table.

19. The method of claim 16, wherein the hole brackets are slideable along the headpiece rail mount for the aligning with the any configuration of the headpiece mounting ports in the massage table.

20. The method of claim 16, wherein the sliding includes the headpiece cradle sliding from a first side edge of the massage table to a second side edge of the massage table.
